(19) United States
(12) Patent Application Publication
(10) Pub. No.: US 2018/0206664 A1
(43) Pub. Date: Jul. 26, 2018

(54) SLOW COOKER HAVING REMOVABLE CONTAINER WITH HINGED LID

(71) Applicant: Select Brands, Inc., Lenexa, KS (US)

(72) Inventors: Mark T. Krasne, Stilwell, KS (US); Xiujie Yu, Ningbo (CN)

(73) Assignee: Select Brands, Inc., Lenexa, KS (US)

(21) Appl. No.: 15/878,197

(22) Filed: Jan. 23, 2018

Related U.S. Application Data
(60) Provisional application No. 62/449,815, filed on Jan. 24, 2017.

(51) Int. Cl. A47J 27/12; A47J 36/06; A47J 36/16

(52) U.S. Cl. CPC A47J 27/12; A47J 36/16; A47J 36/06

(57) ABSTRACT

A slow cooker includes a housing and a removable container. The housing includes a heated receptacle that removably receives the container and is configured to heat the container received therein. The container includes a bowl and a lid that cooperatively define a cooking chamber to receive the food. The bowl and lid are shiftable into and out of a closed position where the bowl and lid cooperatively restrict food ingress and egress relative to the chamber. The container includes a bowl connector and a lid connector associated with the bowl and the lid, respectively. The bowl connector and lid connector are coupled relative to one another to interconnect the bowl and the lid, with the bowl and the lid being shiftable with each other relative to the housing.

### RELATED APPLICATION

This application claims the benefit of U.S. Provisional Application Ser. No. 62/449,815, filed Jan. 24, 2017, entitled HINGED LID INSERT-MULTIPLE INSERT BUFFET SERVER, which is hereby incorporated in its entirety by reference herein.

### BACKGROUND

### 1. Field

The present invention relates generally to slow cookers. More specifically, embodiments of the present invention concern a slow cooker with a housing and a removable container including a bowl and a lid shiftable with each other relative to the housing.

### 2. Discussion of Prior Art

Slow cookers are widely available and are used to heat various foods for several hours at a time. Prior art slow cookers include a housing along with one or more removable bowl inserts. Each insert is associated with a removable lid used to cover the insert. The housing includes an electric heating element to apply heat to the insert and food contained therein. The bowl insert generally comprises a ceramic or similar material configured to be heated while serving to insulate the food from heat loss.

However, conventional slow cookers have numerous deficiencies. For example, it is well known that the lid of a slow cooker can be inadvertently displaced from the bowl insert when the slow cooker is moved (e.g., when transporting the slow cooker). Similarly, when the bowl insert and lid are moved separately from the remainder of the slow cooker, the lid can be inadvertently displaced from the bowl insert.

### SUMMARY

The following brief summary is provided to indicate the nature of the subject matter disclosed herein. While certain aspects of the present invention are described below, the summary is not intended to limit the scope of the present invention.

Embodiments of the present invention provide a slow cooker that does not suffer from the problems and limitations of the prior art slow cookers set forth above.

A first aspect of the present invention concerns a slow cooker configured to heat food. The slow cooker broadly includes a housing and a removable container. The housing includes a heated receptacle that removably receives the container and is configured to heat the container received therein. The container includes a bowl and a lid that cooperatively define a cooking chamber to receive the food, with the bowl and lid being shiftable into and out of a closed position where the bowl and lid cooperatively restrict food ingress and egress relative to the chamber. The container further includes a bowl connector and a lid connector associated with the bowl and the lid, respectively. The bowl connector and the lid connector are coupled relative to one another to interconnect the bowl and the lid, with the bowl and the lid being shiftable with each other relative to the housing.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a front perspective of a slow cooker constructed in accordance with a preferred embodiment of the present invention, showing containers seated within a housing of the slow cooker, with a first container having a lid in a closed position, a second container having a lid in a fully open position, and a third container having a lid in an intermediate open position;

FIG. 2 is a front perspective of the slow cooker shown in FIG. 1, showing all lids in the closed position;

FIG. 3 is a rear perspective of the slow cooker similar to FIG. 2, but taken from the opposite side of the slow cooker;

FIG. 4 is an exploded perspective of the slow cooker shown in FIGS. 1-3, showing the containers removed from heated receptacles of the housing;

FIG. 5 is an exploded upper perspective of one of the containers shown in FIGS. 1-4, showing a bowl and lid of the container detached from each other, with the container including opposite bowl connectors and a lid connector to selectively connect the bowl and lid;

FIG. 6 is a lower perspective of the container shown in FIGS. 1-5, showing the lid connector detached from a corresponding bowl connector;

FIG. 7 is a fragmentary lower perspective of the container shown in FIGS. 1-6, showing the lid connector exploded from the lid;

FIG. 8 is a fragmentary lower perspective of the container shown in FIGS. 1-7, showing the bowl connectors exploded from a body of the bowl;

FIG. 9 is a cross section of the slow cooker shown in FIGS. 1-4, showing the lid in a closed position, with the lid in sealing engagement with a rim of the bowl, and showing a catch shifted into a locking position;

FIG. 10 is a cross section of the slow cooker similar to FIG. 9, but showing the catch shifted into an unlocking position and the lid rotated upwardly out of the closed position;

FIG. 11 is a cross section of the slow cooker similar to FIG. 10, but showing the lid rotated into the closed position, and showing a latch of the bowl connector shifted into an unlatched position; and

FIG. 12 is a cross section of the slow cooker similar to FIG. 11, but showing the lid shifted upwardly away from the bowl, with the lid connector shifted out of engagement with the corresponding bowl connector.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

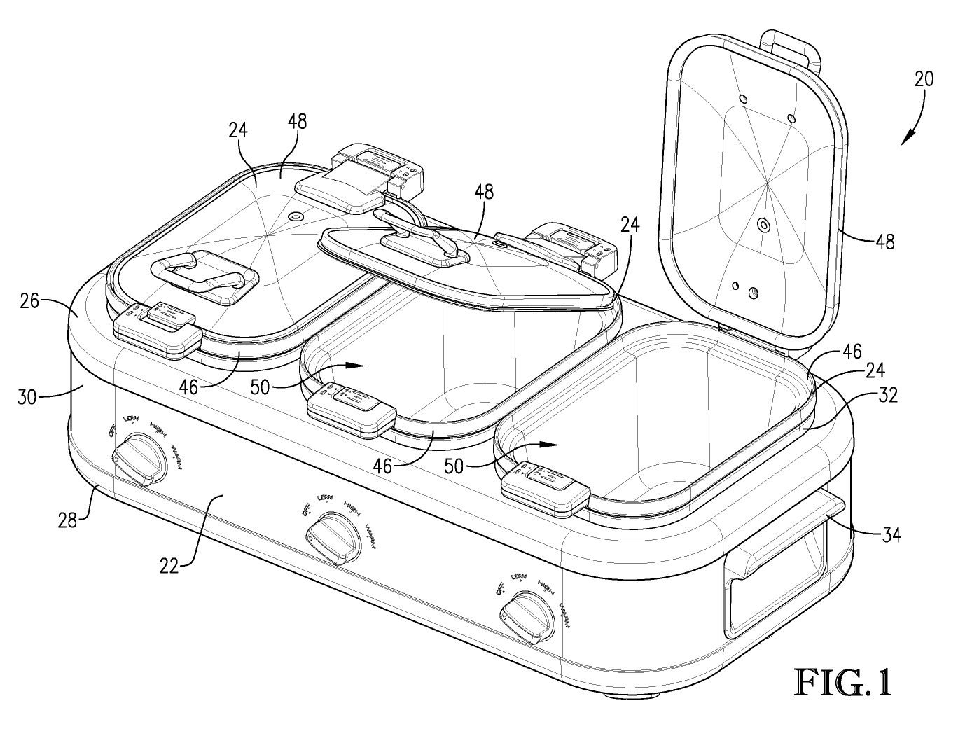

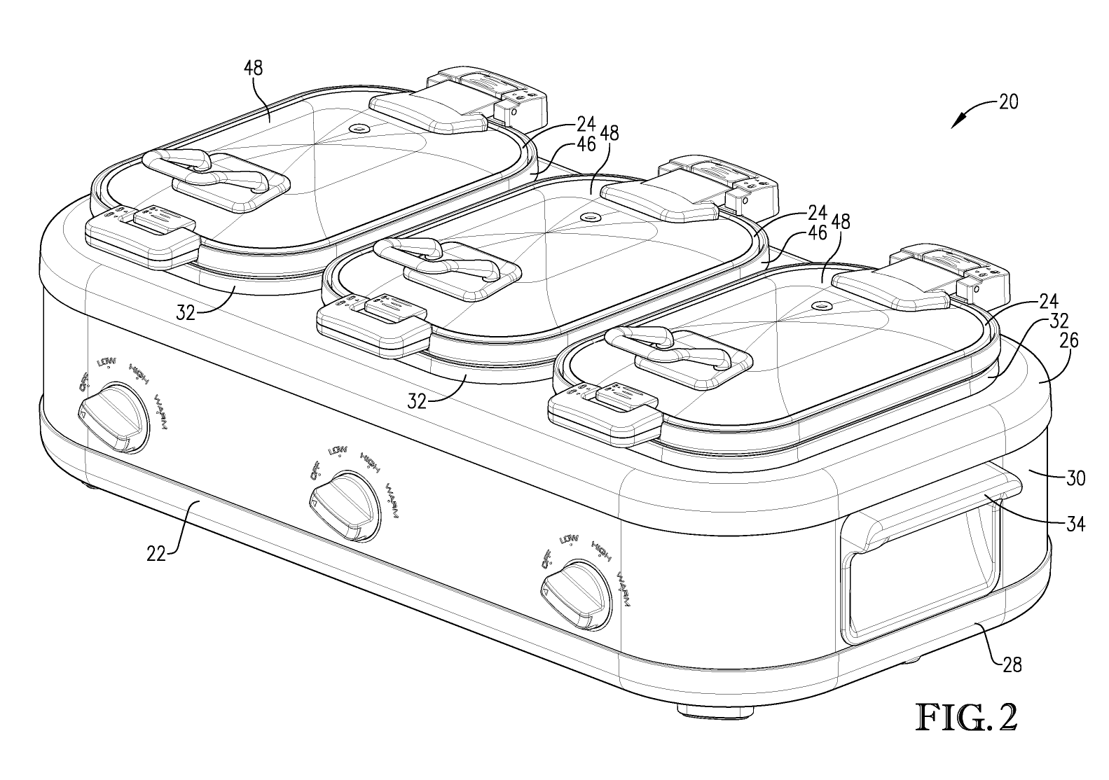

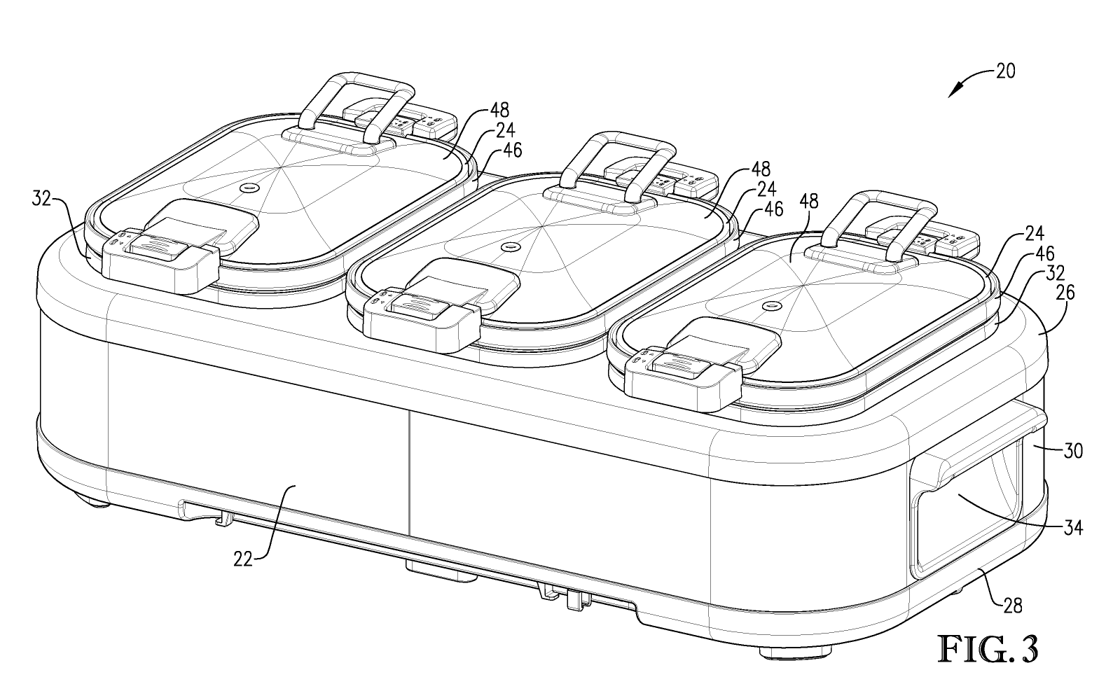

Turning initially to FIGS. 1-4, a slow cooker 20 is configured to heat various types and amounts of foods (not shown), including foodstuffs (not shown). In the usual manner, the slow cooker 20 can provide heat to raise the temperature of the food or to generally maintain the food at a desired temperature (e.g., a temperature above ambient conditions). The depicted slow cooker 20 is generally configured to heat food so that the food temperature is raised and/or maintained over the course of several hours. However, the principles of the present invention are equally applicable where the cooker is operable to heat food at a relatively faster rate (e.g., where the food is heated to a desired temperature in less one hour).

Although the slow cooker 20 is particularly used to heat foods and foodstuffs, the slow cooker 20 could also be configured to heat other substances. For instance, in some alternative embodiments and applications, the cooker could be configured to heat and contain substances (e.g., substances in the form of liquids, solids, gels, etc.) that are not foods.

The slow cooker 20 preferably includes a housing 22 and three (3) removable containers 24. The three (3) removable containers 24 are preferably substantially identical to one another, although the slow cooker 20 could have containers that are shaped differently from one another. It will also be appreciated that the slow cooker 20 could include an alternative number of removable containers without departing from the spirit of the present invention. For instance, an alternative slow cooker could include only one or two removable containers. On the other hand, other alternative slow cookers could include more than three removable containers.

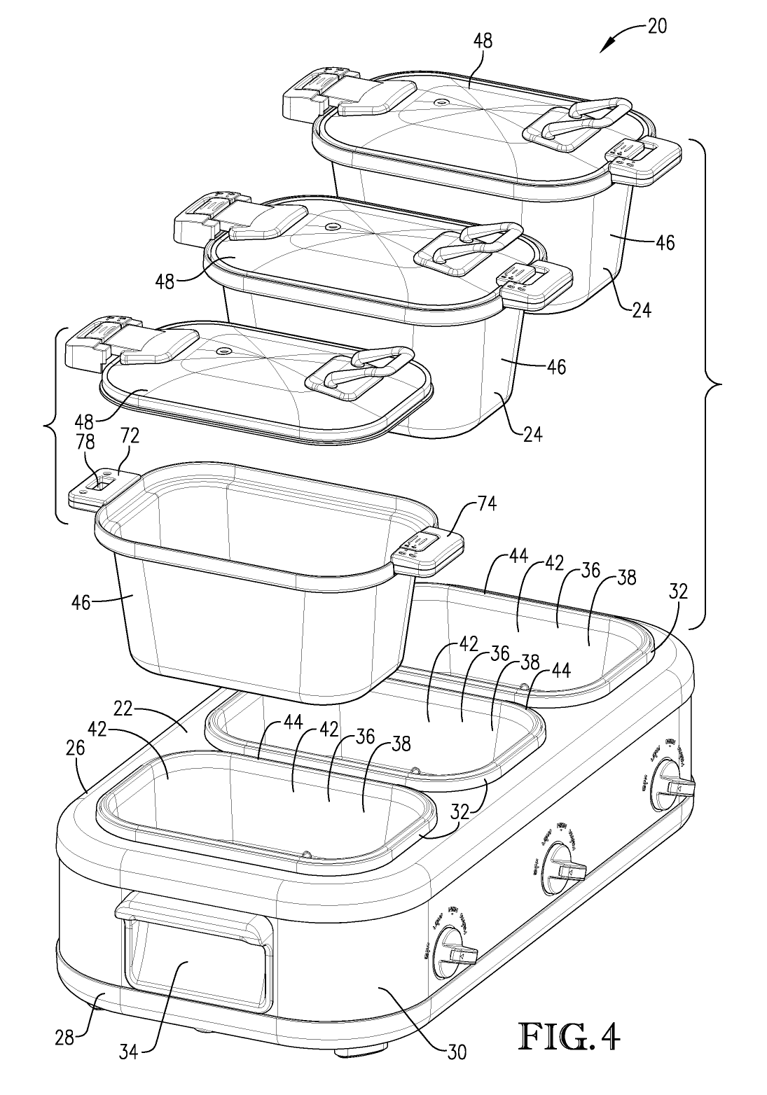

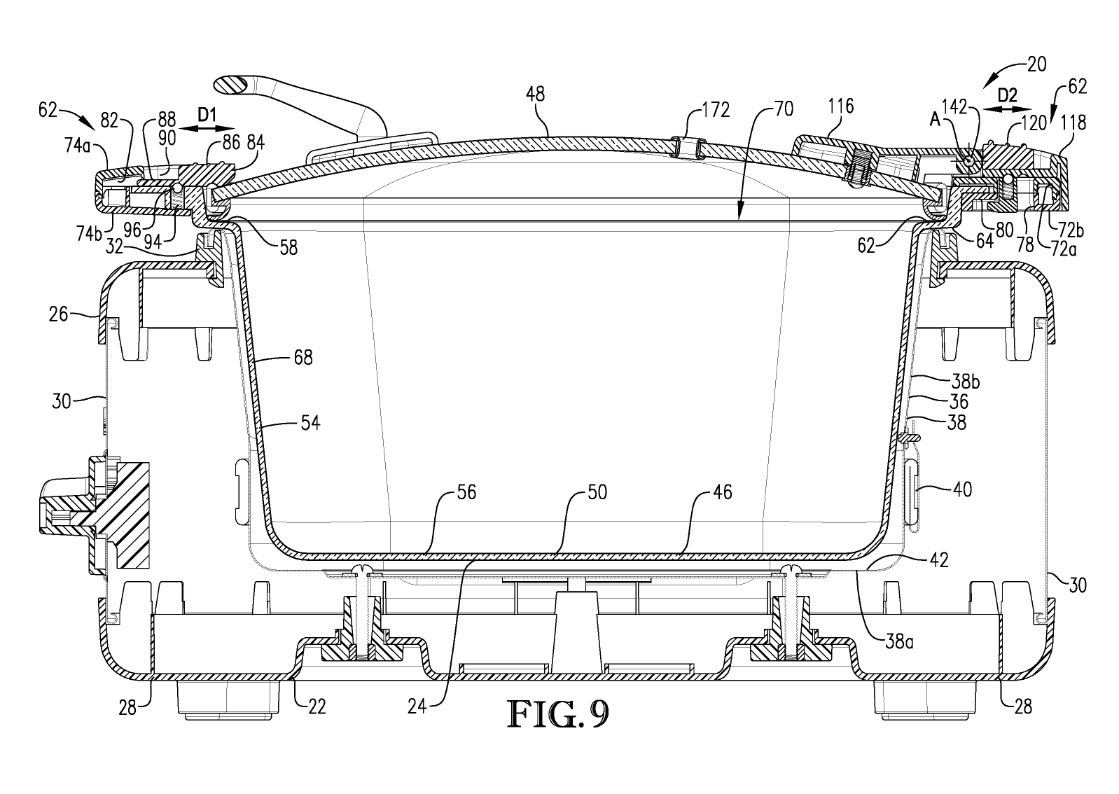

The housing 22 preferably serves as a stable base structure to removably support the containers 24 while being configured to selectively heat the containers 24. Preferably, the housing 22 includes, among other things, upper and lower sections 26,28, a sidewall 30, rims 32, opposite handles 34, and heated receptacles 36 (see FIGS. 4 and 9).

The heated receptacle 36 is operable to slidably receive one of the containers 24 and selectively heat the container 24 received therein. The heated receptacle 36 preferably includes a metallic open tub 38 and a heating element 40 (see FIG. 9).

The tub 38 includes a metallic sheet formed to present a bottom 38a and a sidewall 38b that cooperatively form a cavity 42 (see FIG. 9). The tub 38 also presents an open top 44 that communicates with the cavity 42 (see FIG. 4). The tub 38 is preferably shaped so that at least part of the sidewall 38b is in close conformity with the container 24 (see FIG. 9). More particularly, the bowl of the illustrated container 24 fits snugly within the cavity 42 while being shiftable into and out of the cavity 42.

In the usual manner, the heating element 40 provides an electrically powered heat source. The heating element 40 is elongated and extends circumferentially about the sidewall 38b of the tub 38. The depicted heating element 40 is also located above the bottom 38a. However, the heating element 40 could be alternatively positioned relative to the tub 38 consistent with the principles of the present invention.

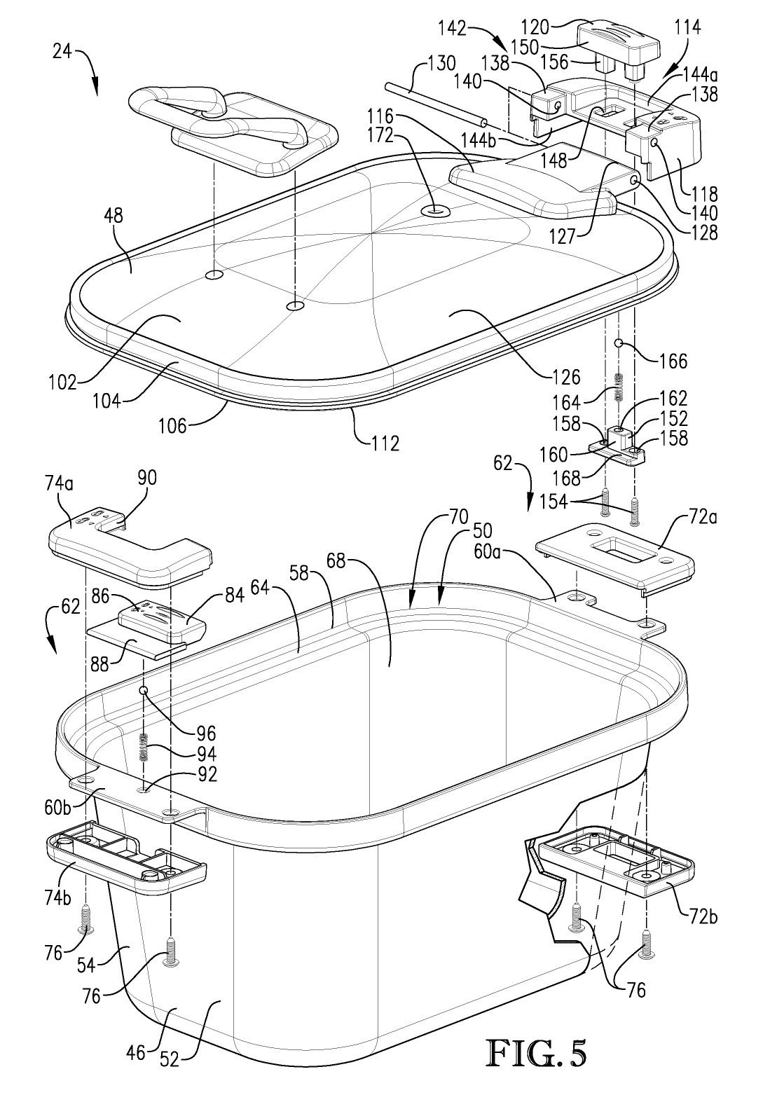

Turning to FIGS. 5-12, the removable containers 24 can be selectively used to receive food (not shown) for heating. As will be described in detail, each container 24 has a bowl 46 and a lid 48 that cooperatively define an enclosed cooking chamber 50 to receive the food (see FIG. 9). The bowl 46 and lid 48 are preferably shiftable with each other relative to the housing 22. In particular, the bowl 46 and lid 48 are shiftable with each other as the container 24 is shifted into and out of the cavity 42 of the receptacle 36 (see FIG. 4).

The bowl 46 and lid 48 are also shiftable into and out of a closed position where the bowl 46 and lid 48 cooperatively restrict food ingress and egress relative to the chamber 50 (see FIG. 9). Preferably, the container 24 can be inserted and removed relative to the receptacle 36 as a unit so that the container 24 can be used independently of the remainder of the cooker 20.

Turning to FIGS. 5, 6, 8, and 9, the bowl 46 preferably includes a unitary body 52 with an endless sidewall 54, bottom 56, an endless rim 58, and opposite tabs 60a,b. The bowl 46 is preferably elongated to present a generally rectangular-shaped profile with rounded corners and ends 62 that are longitudinally spaced apart from each other. However, the bowl 46 could have an alternative profile shape without departing from the scope of the present invention (e.g., where the bowl has a profile shape that is generally square, oval, or circular). For any bowl profile shape, it is preferable that the bowl and lid are complementally shaped to permit sealing engagement therebetween.

The body 46 presents inner and outer shoulders 64,66 that extend endlessly along the rim 58. The bowl 46 also presents an interior basin 68 and an open top 70 that communicate with one another. In the usual manner, food can be passed through the open top 70 and positioned within the basin 68.

Again, the bowl 46 of the container 24 fits snugly within the cavity 42 while being shiftable into and out of the cavity 42. When positioned within the cavity 42, the outer shoulder 66 of the rim 58 is preferably seated on the corresponding rim 32 of the housing 22. In the illustrated embodiment, the bowl 46 is shiftable into and out of the cavity 42 of the receptacle 36. Most preferably, the bowl 46 can be shifted into and out of the cavity 42 either with or without the lid 48 attached thereto.

The body 52 preferably comprises a metallic material, such as aluminum or steel. However, the body 52 could include other materials, such as a ceramic material and/or a synthetic resin material, without departing from the scope of the present invention.

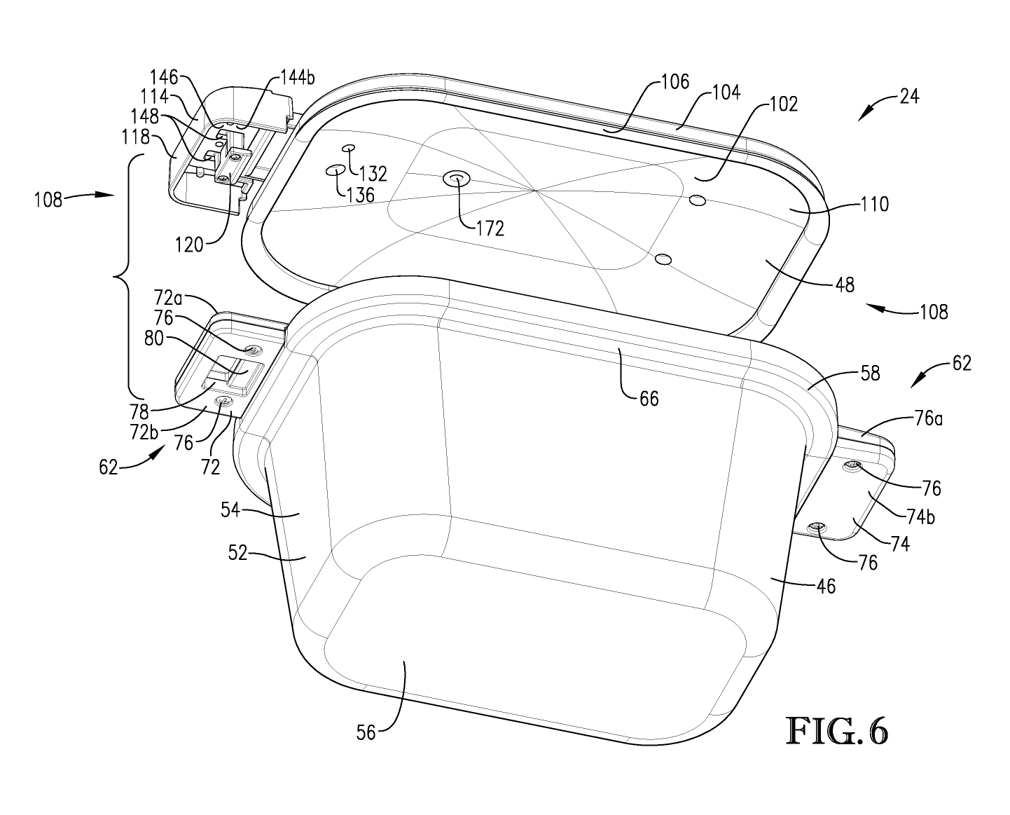

The container 24 also preferably includes opposite bowl connectors 72,74 removably attached to corresponding tabs 60a,b with fasteners 76 (see FIGS. 4, 6, and 8). The depicted bowl connector 72 includes upper and lower plates 72a,b secured to the tab 60a. The plates 72a,b cooperatively form an opening 78 and a shoulder 80 adjacent the opening 78 (see FIGS. 6 and 9). As will be described, the lid 48 is associated with a lid connector that is removably received by the opening 78 and removably engages the shoulder 80.

The bowl connector 74 includes upper and lower plates 74a,b secured to the tab 60b. The plates 74a,b cooperatively present a slotted opening 82 therebetween (see FIG. 9). The bowl connector 74 further includes a slidable catch 84. The catch 84 is unitary and includes a button element 86 and a tab element 88 that are integrally formed. The catch 84 is slidably received between the plates 74a,b, with the tab element 88 located at least partly in the slotted opening 82.

The catch 84 is slidably mounted within the slotted opening 82. The upper plate 74a and tab 60b cooperatively present an upper channel 90 that slidably receives the button element 86 (see FIGS. 5 and 9).

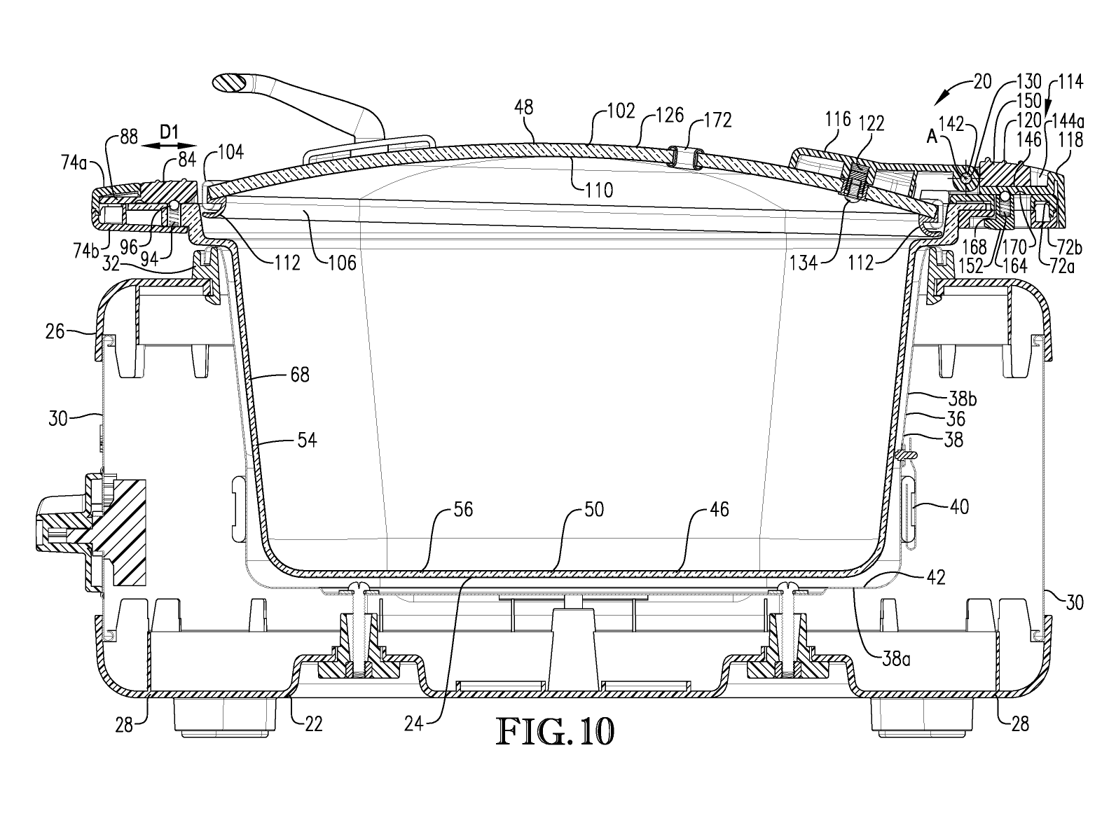

The catch 84 is slidably received by the plates 74a,b and is slidable along a locking direction D1 between a locking position (see FIG. 9) and an unlocking position (see FIG. 10).

The tab 60b also presents a hole 92 that slidably receives a coil spring 94 and a ball 96, with a lower end of the spring 94 engaging the plate 74b (see FIGS. 5, 8, and 9).

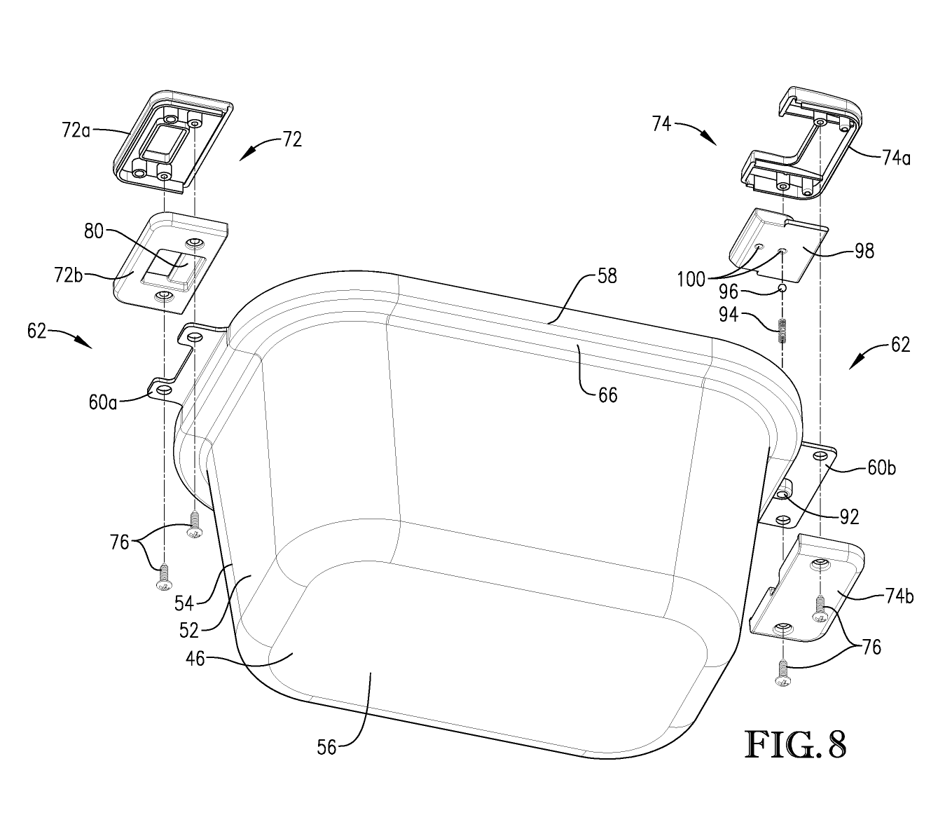

A bottom surface 98 of the catch 84 presents a pair of spaced apart dimples 100 (see FIG. 8). The dimples 100 are configured to partly receive the ball 96 when the catch 84 is in a respective one of the locking and unlocking positions (see FIGS. 9 and 10). In particular, the coil spring 94 urges the ball 96 into engagement with the catch 84.

When the catch 84 is in one of the locking and unlocking positions, the coil spring 94 urges the ball 96 into engagement with a corresponding dimple 100 and thereby restricts movement of the catch 84 out of the respective position. In this manner, the coil spring 94 and ball 96 provide a preferred detent mechanism to locate the catch 84 into one of the locking and unlocking positions. However, it will be appreciated that an alternative detent mechanism could be provided to locate the catch in one of multiple discrete positions.

As will be discussed, the illustrated catch 84 is configured to removably engage the lid 48 in the locking position to restrict lid opening. However, the catch 84 could be alternatively mounted and/or positioned to lock the lid 48 in a closed position. For instance, the catch could be slidably mounted on the lid instead of the bowl. Also, for some aspects of the present invention, the catch could be slidably mounted on part of the housing for removable engagement with the lid.

Turning to FIGS. 5-7 and 10, the lid 48 is configured to cooperate with the bowl 46 to define the cooking chamber 50. The bowl 46 and lid 48 are shiftable into and out of the closed position. In the closed position, the lid 48 is preferably configured to sealingly engage the bowl 46 so that the bowl 46 and lid 48 cooperatively form the chamber 50. The illustrated lid 48 includes a body 102, band 104, and a seal 106.

The lid 48 is preferably elongated to present a generally rectangular-shaped profile with rounded corners and ends 108 that are longitudinally spaced apart from each other (see FIG. 6). However, the lid 48 could have an alternative profile shape without departing from the scope of the present invention (e.g., where the lid has a profile shape that is generally square, oval, or circular). For any lid profile shape, it is preferable that the bowl and lid are complementally shaped to permit sealing engagement therebetween.

The body 102 comprises a substantially transparent glass plate with an endless edge. The plate is curved to present a generally concave interior lid surface 110. The band 104 is substantially endless and is secured to the edge of the body 102. The seal 106 is also endless and includes a wiper 112 (see FIG. 10). The seal 106 is secured between the edge of the body 102 and the band 104.

The container 24 also preferably includes a lid connector 114. The lid connector 114 is operable to be removably attached to the bowl connector 72 so that the container 24 can be selectively opened and closed. The lid connector 114 preferably includes a lid bracket 116, a latch housing 118, and a shiftable latch 120 (see FIG. 5).

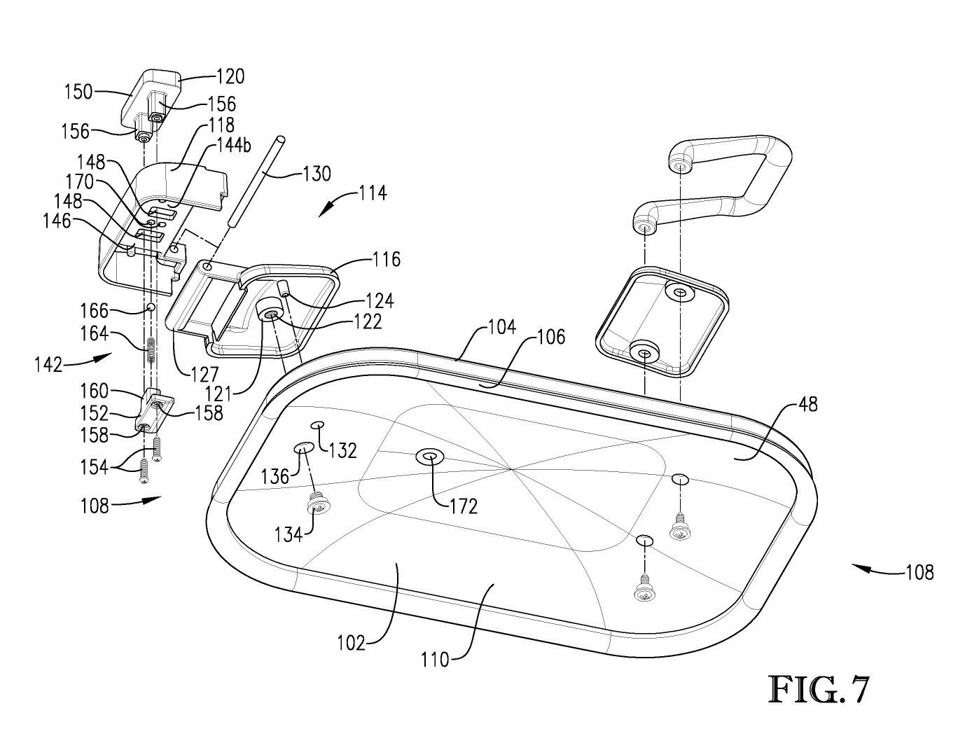

The lid bracket 116 includes a connector element for attachment to the latch housing 118. The lid bracket 116 presents a lid connection interface 121 with a threaded opening 122 and a boss 124 (see FIG. 7). The interface 121 also has a concave lower margin that conforms to the convex shape of an exterior lid surface 126 of the lid 48. The lid bracket 116 also includes a bracket end 127 that presents a continuous bore 128, which slidably receives a pin 130 (see FIGS. 5 and 7)).

The lid bracket 116 is fixed to the lid 48 by locating the boss 124 within a hole 132 presented by the body 102 and securing a fastener 134 through another hole 136 and the threaded opening 122 (see FIGS. 7 and 10).

The latch housing 118 includes a connector element configured to be swingably attached to the lid bracket 116 to allow relative swinging movement therebetween. The latch housing 118 preferably includes opposite tabs 138 that present holes 140 to receive the pin 130 (see FIG. 5). The tabs 138 are spaced apart to slidably receive the bracket end 127. The holes 140 and bore 128 are configured to be aligned to receive the pin 130. Thus, the lid bracket 116 and latch housing 118 provide connector elements that are swingably attached to form a hinged joint 142 (see FIG. 10). As will be explained, the hinged joint 142 facilitates relative swinging between the bowl 46 and the lid 48.

Although the hinged joint 142 is preferably provided by the lid connector 114, the hinged joint 142 could be alternatively provided to permit swinging movement of the lid 48 relative to the bowl 46. For instance, the bowl connector 72 could be configured to include a hinge mechanism that provides a hinged joint to permit swinging movement between the lid and bowl. Furthermore, the lid connector and bowl connector could be swingably attached to each other to cooperatively provide a hinge mechanism that forms a hinged joint.

The latch housing 118 also presents upper and lower channels 144a,b separated by a wall 146 (see FIGS. 5-7). The wall 146 presents slots 148 that extend between the channels 144a,b (see FIGS. 5-7).

The latch 120 is preferably shiftably mounted and includes a button element 150 and a latch element 152 connected to each other with fasteners 154 (see FIGS. 5-7). The button element 150 includes internally-threaded posts 156 that are spaced apart from each other (see FIGS. 6 and 7). The button element 150 is slidably mounted on the latch housing 118 by seating the button element 150 within the upper channel 144a, with the posts 156 extending through respective slots 148 (see FIGS. 6 and 10).

The latch element 152 presents countersunk holes 158 that receive the posts 156 and the fasteners 154 (see FIGS. 5 and 7). The latch element 152 also includes a post 160 located between the holes 158. The post 160 presents a blind hole 162 that slidably receives a coil spring 164 and a ball 166 (see FIGS. 5-7). The latch element 152 further presents a latch shoulder 168 configured to engage the shoulder 80 presented by the bowl connector 72 (see FIGS. 9 and 10). The latch element 152 is positioned within the lower channel 144b and connected to the posts 156 of the button element 150 with fasteners 154.

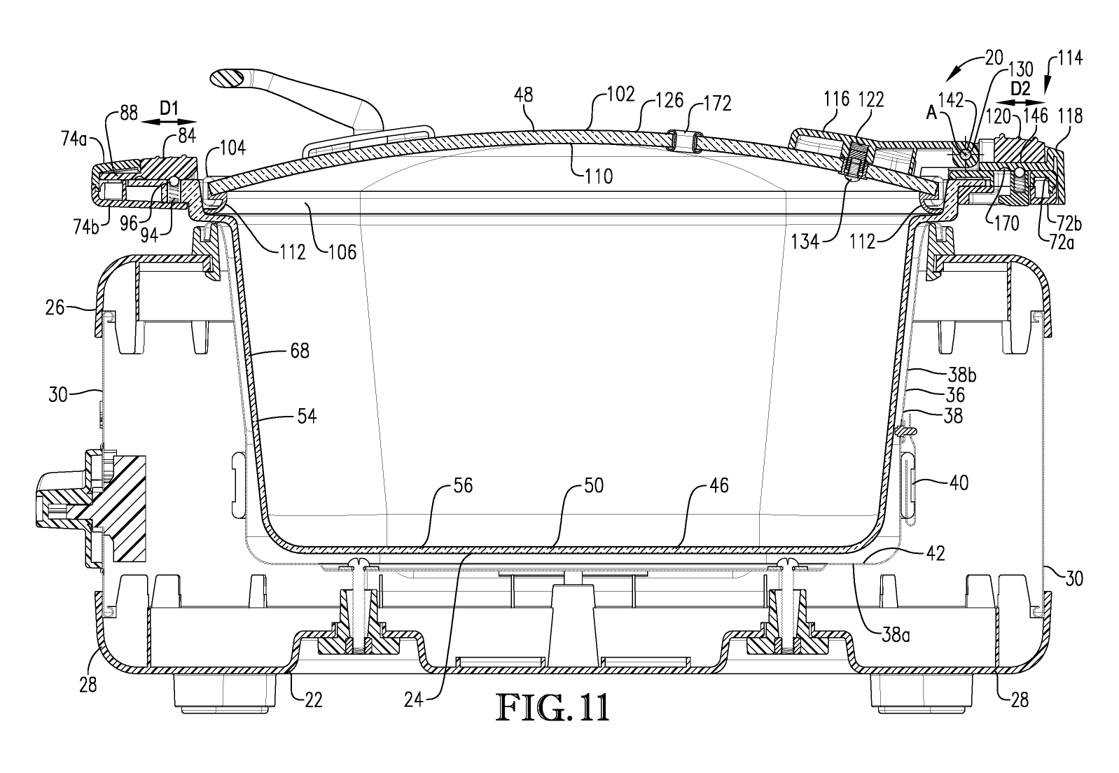

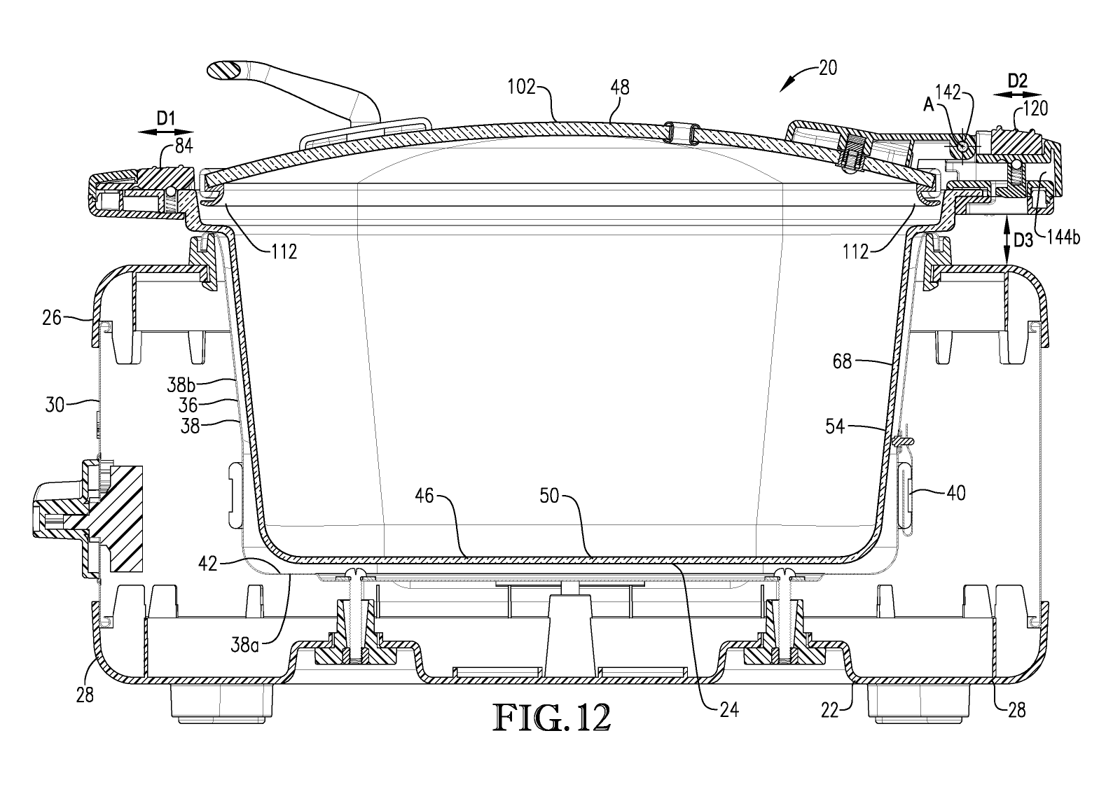

The latch 120 is slidably received on the latch housing 118 and is slidable along a longitudinal latching direction D2 between a latched position (see FIGS. 9 and 10) and an unlatched position (see FIGS. 11 and 12). It is also within the ambit of the present invention where the latch 120 is alternatively shiftable between the latched and unlatched positions. For instance, the latch could be laterally slidable in a direction transverse to the depicted longitudinal direction. In another alternative embodiment, the latch could be vertically shiftable (e.g., where the latch housing shifts into and out of engagement with the bowl connector along a lateral direction). Furthermore, the latch could be pivotally mounted on the latch housing 118 so as to pivot between the latched and unlatched positions.

The wall 146 of the latch housing 118 presents a pair of spaced apart dimples 170 located between the slots 148 (see FIG. 7). The dimples 170 are configured to partly receive the ball 166 when the latch 120 is in a respective one of the latched and unlatched positions. In particular, the coil spring 164 urges the ball 166 into engagement with the wall 146. When the latch 120 is in one of the latched and unlatched positions, the coil spring 164 urges the ball 166 into engagement with a corresponding dimple 170 and thereby restricts movement of the latch out of the respective position.

In this manner, the coil spring 164 and ball 166 provide a preferred detent mechanism to locate the latch 120 into one of the latched and unlatched positions. However, it will be appreciated that an alternative detent mechanism could be provided to locate the latch in one of multiple discrete positions.

The bowl connector 72 and lid connector 114 are preferably removably coupled relative to one another to interconnect the bowl 46 and the lid 48. At the same time, the connectors 72,114 interconnect the bowl 46 and lid 48 so that the bowl 46 and lid 48 are shiftable with each other relative to the housing 22.

The depicted bowl connector 72 and lid connector 114 are removably attached to one another and permit the bowl 46 and lid 48 to be selectively detached from each other. In particular, the connectors 72,114 are shiftable into and out of an engagement position where the connectors 72,114 are engaged with each other for removable attachment (see FIGS. 9-11).

The connectors 72,114 are shiftable relative to one another along a vertical connector seating direction D3 (see FIG. 12) when moving into and out of the engagement position. In the engagement position, the latch 120 of the lid connector 114 is removably received by the opening 78. Furthermore, the bowl connector 72 is removably received by the lower channel 144b so that the bowl connector 72 and latch housing 118 cooperatively restrict relative movement therebetween.

However, the bowl connector 72 and the latch housing 118 could be alternatively configured for removable engagement with each other. For instance, the latch housing 118 could be slidable into and out of engagement with the bowl connector 72 by sliding along the longitudinal direction or another lateral direction.

The latch 120 is preferably slidable between the latched position (see FIGS. 9 and 10) and the unlatched position (see FIGS. 11 and 12) by sliding along the latching direction D2, which is transverse to the connector seating direction D3.

The depicted latch 120 is slidable into and out of the latched position, where the latch 120 is attached to the bowl connector 72 to prevent disengagement of the connectors 72,114 along the connector seating direction D3. Most preferably, the shoulder 168 of the latch element 152 is located in removable engagement with the shoulder 80 of the bowl connector 72 in the latched position (see FIGS. 9 and 10). However, the latch element 152 and/or the bowl connector 72 could be alternatively configured for removable latching engagement therebetween.

Similarly, the illustrated latch 120 is slidable into and out of the unlatched position, where the shoulder 168 of the latch 120 is disengaged from the shoulder 80 of the bowl connector 72 (see FIG. 11). Disengagement of the shoulders 80,168 permits the connectors 72,114 to move relative to each other along the connector seating direction D3 (see FIGS. 11 and 12).

Again, the lid connector 114 preferably includes the latch 120, while the bowl connector 72 presents the opening 78 to slidably receive the latch 120. However, it is within the ambit of the present invention where the connectors 72,114 are reversed so that the bowl connector includes a latch and the lid connector presents an opening to slidably receive the latch.

As discussed above, the lid 48 and bowl 46 define the cooking chamber 50. The illustrated lid 48 is swingable relative to the bowl 46 between the closed position and various open positions (see FIGS. 1, 9, and 10). The hinged joint 142 preferably facilitates relative swinging between the bowl 46 and the lid 48. In the depicted embodiment, the hinged joint 142 is located adjacent the bowl 46 and defines a lateral hinge axis A (see FIGS. 9 and 10). The hinge axis A permits the lid 48 to swing vertically relative to the bowl 46.

However, it is within the scope of the present invention where the hinged joint 142 is alternatively configured. For instance, the hinged joint 142 could have an alternative position relative to the bowl (e.g., where the hinged joint is located between the ends of the bowl).

In the open position, the lid 48 and bowl 46 cooperatively permit food ingress and egress relative to the chamber 50. In the closed position, the lid 48 is preferably configured to substantially span the open top 70. Most preferably, the lid 48 sealingly engages the bowl 46 along substantially the entire length of the rim 58 in the closed position to restrict chamber ingress and egress. However, for some aspects of the present invention, the bowl and/or lid could be alternatively configured so that the bowl and lid are not in sealing engagement in the closed position.

Most preferably, the hinged joint 142 of the depicted container 24 permits the lid 48 to swing relative to the bowl 46 while the container 24 is seated within the cavity 42 of the corresponding heated receptacle 36. Furthermore, the hinged joint 142 also preferably allows the lid 48 to swing relative to the bowl 46 while the containers 24 is positioned entirely outside the cavity 42. In this manner, the lid 48 of the container 24 can be selectively open and closed whether or not the container 24 is received in the housing 22. Similarly, the lid 48 can be selectively locked in the closed position and unlocked whether or not the container 24 is received in the housing.

However, for some aspects of the present invention, lid movement relative to the bowl and/or locking of the lid could be restricted when the container 24 is removed from the housing 22.

Although the lid and bowl are in sealed engagement when the lid is closed, the lid presents a vent opening 172 that allows the chamber to be vented in the closed position (see FIG. 9). However, it will be appreciated that the vent opening 172 could be closed (e.g., with a cover or plug structure) so that the chamber is hermetically sealed from ambient.

Again, the depicted catch 84 is slidably mounted on the bowl 46 and is slidable along the locking direction D1 between the locking position and the unlocking position. It is also within the ambit of the present invention where the catch is alternatively shiftable between the locking position and the unlocking position. For instance, the catch could be laterally slidable in a direction transverse to the depicted longitudinal direction. In another alternative embodiment, the catch could be vertically shiftable (e.g., where the lid shifts relative to the bowl in a lateral direction). Furthermore, the catch could be pivotally mounted on the bowl so as to pivot between the locking position and the unlocking position.

When the lid 48 is closed, the catch 84 is configured to engage the lid 48 in the locking position. Thus, when the lid 48 is closed and the catch 84 is locked, the catch 84 restricts upward movement of the lid 48 out of the closed position. In this manner, the illustrated catch 84 is configured to removably engage the lid 48 in the locking position to restrict lid opening.

However, the catch 84 could be alternatively mounted and/or positioned to lock the lid 48 in the closed position. In at least some alternative embodiments, the catch could be slidably mounted on part of the housing for removable engagement with the lid. In other alternative embodiments, the catch could be slidably mounted on the lid instead of the bowl. For such an alternative embodiment, the catch could be configured to engage a slotted opening presented by the bowl to lock the lid in the closed position. For some aspects of the present invention, the slow cooker could be configured so that the alternative catch engages part of the housing to lock the lid in the closed position.

The connectors 72,114 and the bowl connector 74 cooperatively hold the bowl 46 and the lid 48 in engagement with one another in the closed position. Furthermore, the seal 106 is preferably compressed in the closed position so that the bowl 46 and the lid 48 are held in sealing engagement with each other. When the seal is under compression, the seal 106 urges the lid 48 to shift out of the closed position. The principles of the present invention are also applicable where the seal is not compressed in the closed condition.

The illustrated connectors 72,114 and the bowl connector 74 also preferably hold the bowl 46 and lid 48 in engagement with one another while the container 24 is seated within the respective receptacle 36. It will also be understood that the connectors 72,74,114 are configured to maintain the bowl 46 and lid 48 in engagement when the container 24 is positioned entirely outside of the receptacle 36.

In use, one or more lids 48 of the slow cooker 20 can be selectively opened to add and/or remove food relative to one or more of the containers 24. The lid 48 of each container 24 can be selectively closed to enclose the respective chamber 50 and restrict food ingress and egress relative thereto. Each lid 48 can be selectively locked in the closed position by moving the respective catch 84 into the locking position.

Preferably, each container 24 can be selectively inserted and/or removed relative to the cavity 42 of the corresponding receptacle 36. Such movement of the container 24 can be performed whether the container 24 is opened or closed. It will also be appreciated that the container 24 may or may not contain food as the container 24 is inserted and/or removed relative to the receptacle 36.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A slow cooker configured to heat food, said slow cooker comprising:
a housing and a removable container,
said housing including a heated receptacle that removably receives the container and is configured to heat the container received therein,
said container including a bowl and a lid that cooperatively define a cooking chamber to receive the food, with the bowl and lid being shiftable into and out of a closed position where the bowl and lid cooperatively restrict food ingress and egress relative to the chamber,
said container further including a bowl connector and a lid connector associated with the bowl and the lid, respectively,
said bowl connector and said lid connector coupled relative to one another to interconnect the bowl and the lid, with the bowl and the lid being shiftable with each other relative to the housing.

2. The slow cooker as claimed in claim 1,
said connectors being removably attached to one another and permitting the bowl and lid to be selectively detached from each other.

3. The slow cooker as claimed in claim 2,
said connectors being shiftable into and out of an engagement position where the connectors are engaged with each other for removable attachment, with the connectors being shiftable relative to one another along a connector seating direction when moving into and out of the engagement position.

4. The slow cooker as claimed in claim 3,
one of said connectors including a housing and a shiftable latch element shiftably mounted on the housing, with the other of said connectors presenting an opening that slidably receives the latch element in the engagement position and permits slidable latch movement relative thereto along the connector seating direction.

5. The slow cooker as claimed in claim 4,
said latch element being slidable between a latched position, where the latch element is attached to the other connector to prevent disengagement of the connectors along the connector seating direction, and an unlatched position, where the latch element is detached from the other connector to permit relative sliding movement therebetween along the connector seating direction.

6. The slow cooker as claimed in claim 5,
said latch element being slidable between the latched position and the unlatched position in a latching direction transverse to the connector seating direction.

7. The slow cooker as claimed in claim 1,
said lid being shiftably supported relative to the bowl by the connectors to shift between the closed position and an open position where the lid and bowl cooperatively permit food ingress and egress relative to the chamber,
one of said bowl and said lid including a shiftable catch that is shiftable into and out of a locking position,
said shiftable catch removably engaging the other one of said bowl and said lid when the lid is closed and the catch is in the locking position to restrict lid opening.

8. The slow cooker as claimed in claim 7,
said lid presenting opposite lid ends, with the connectors located at one of the lid ends and the shiftable catch located at the other one of the lid ends.

9. The slow cooker as claimed in claim 8,
at least one of said connectors forming a hinged joint that facilitates relative swinging between the bowl and the lid, with the bowl and lid being swingable between the open and closed positions,
said catch restricting the lid from swinging out of the closed position when the catch is in the locking position.

10. The slow cooker as claimed in claim 9,
said lid connector including a pair of connector elements swingably attached to form the hinged joint.

11. The slow cooker as claimed in claim 10,
said hinged joint being located adjacent the bowl and defining a lateral hinge axis that permits the lid to swing vertically relative to the bowl.

12. The slow cooker as claimed in claim 7,
said bowl presenting an open top, with the lid substantially spanning the open top in the closed position.

13. The slow cooker as claimed in claim 12,
said bowl and said lid sealingly engaged in the closed position to restrict chamber ingress and egress, with the connectors and the shiftable catch cooperatively holding the bowl and the lid in sealing engagement with one another.

14. The slow cooker as claimed in claim 13,
said lid including an outer frame and a lid seal that extends along the frame and sealingly engages the bowl,
said lid seal being compressed in the closed position so that the lid seal urges the lid to shift out of the closed position.

15. The slow cooker as claimed in claim 1,
said lid being shiftably supported relative to the bowl by the connectors to shift between the closed position and an open position where the lid and bowl cooperatively permit food ingress and egress relative to the chamber.

16. The slow cooker as claimed in claim 15,
at least one of said connectors forming a hinged joint that facilitates relative swinging between the bowl and the lid, with the bowl and lid being swingable between the open and closed positions.

17. The slow cooker as claimed in claim 16,
said lid connector including a pair of connector elements swingably attached to form the hinged joint.

18. The slow cooker as claimed in claim 17,
said hinged joint being located adjacent the bowl and defining a lateral hinge axis that permits the lid to swing vertically relative to the bowl.

19. The slow cooker as claimed in claim 1,
said bowl presenting an open top, with the lid substantially spanning the open top when the lid is closed.

20. The slow cooker as claimed in claim 19,
said bowl and said lid sealingly engaged when closed to restrict chamber ingress and egress.

21. The slow cooker as claimed in claim 20,
said lid including an outer frame and a lid seal that extends along the frame and sealingly engages the bowl,
said lid seal being compressed in the closed position so that the lid seal urges the lid to shift out of the closed position.

22. The slow cooker as claimed in claim 1,
said receptacle including a sleeve and a powered heating element that removably receive the container.

23. The slow cooker as claimed in claim 22,
said sleeve presenting an open receptacle top that receives the bowl, with the lid being spaced above the open receptacle top.
